(19) United States
(12) Patent Application Publication
(10) Pub. No.: US 2005/0109687 A1
(43) Pub. Date: May 26, 2005

(54) Treating apparatus for organic waste

(76) Inventor: Su-Ching Su, Taipei Hsien (TW)

Correspondence Address: BACON & THOMAS, PLLC, 625 SLATERS LANE, FOURTH FLOOR, ALEXANDRIA, VA, 22314, US

(21) Appl. No.: 10/720,199

(22) Filed: Nov. 25, 2003

(51) Int. Cl. C02F 3/00

(52) U.S. Cl. 210/202; 210/210; 210/217

(57) ABSTRACT

The treating apparatus for organic waste mainly is provided in a machine with a receiving room and a water cleaning room, the receiving room has a screening device; the screening device is driven by a driving device, and is provided therein with compound bacteria that can fast bacterialize and decompose organic material. When waste enters the screening device, the organic material can be decomposed and turned into water by using fermentation and decomposing of the compound bacteria, and then the water flows into the water cleaning room to deodorize and sterilize, the inorganic material unable to be decomposed is separated by the screening device, and thereby an object of concentrated treating is achieved.

### BACKGROUND OF THE INVENTION

1. Field of the Invention

The present invention is related to a treating apparatus for organic waste, the apparatus can fast decompose organic waste and can collect the inorganic waste that is unable to be decomposed.

2. Description of the Prior Art

Water, air and food are the three main elements for maintaining lives of living things, as to humankind, three meals taken in due time are necessary for a day to supplement energy consumed in this day; in accompaniment with elevation of the quality of material life, drinking and eating in every three meals are even more highly thought of, visual delicate arrangement is asked for in addition to balancing nutrient to stimulate appetite and desire of purchasing of consumers and attract more of the masses.

And therefore, a dish of delicious food is often gotten by only taking the most delicious parts for cooking, this can make fine of the food and to give good flavor. Under the presupposition of preferring fineness and good looking, not only the food itself is tasty that can attract consumers, but also the entire delicate arrangement for displaying is requisite to foil the food.

Things generally used to foil foods are vegetables and fruits carved, or decorative flowers, in order that displaying of them and the skill of carving can make foods more attractive.

However, no matter it is in a restaurant, an office, a family or a school, large amount of garbage food that are unable to be eaten up because overly much food has been taken for cooking are often left, and flowers for displaying or vegetables and fruits carved are often not eaten by consumers and thereby become a part the garbage food. In view of this, machines for the garbage food are really necessary for those places having overly much garbage food.

Garbage disposers in the markets mainly separate water and residuum in garbage by dealing with the garbage food with organic and inorganic materials mixed therein through the processes of stirring, breaking and crushing for dehydrating etc. the garbage brings some sticky residuum emitting disgusting bad odor, it must be filtered, sterilized and diluted and cleaned with water cleaning equipment before discharging.

While garbage food having water removed is dealt with together with normal garbage, but in most garbage food having water removed, organic and inorganic materials are mixed, this not only largely increases the amount of garbage, but also makes a big worriable problem in dealing with garbage.

### SUMMARY OF THE INVENTION

In view of the above statement, the inventor of the present invention developed successfully the “treating apparatus for organic waste” of the present invention based on his professional experience of years in studying, designing and manufacturing same kind of products and after hard study, developing, as well as repeated experiments and tests.

Thereby the “treating apparatus for organic waste” of the present invention mainly is provided in a machine with a receiving room and a water cleaning room, the receiving room has a screening device; the screening device is driven by a driving device, and is provided therein with compound bacteria that can fast bacterialize and decompose organic material, and can connect exteriorly with an input device for getting in of waste.

The object of the present invention is: with the structure of the above stated “treating apparatus for organic waste”, when the waste having organic and inorganic materials enters the screening device from the input device, the organic material can be decomposed and turned into water by using the compound bacteria, and then flows into the water cleaning room to deodorize and sterilize, the inorganic material unable to be decomposed is separated by the screening device, and thereby an object of concentrated treating is achieved.

Another object of the present invention is: with the water cleaning room, water obtained by decomposition of garbage food can be directly filtered, deodorized and sterilized and then discharged out of the machine, this can reduce the time for removing the garbage food, and save the space for connecting exteriorly a water cleaning device.

The present invention will be apparent in its content and effects to be achieved after reading the detailed description of the preferred embodiment thereof in reference to the accompanying drawings.

### BRIEF DESCRIPTION OF THE DRAWINGS

FIG. 1 is a schematic sectional view of the present invention;

FIG. 2 is an analytic perspective view showing a driving device of the present invention;

FIG. 3 is a schematic sectional view of a second embodiment of the present invention;

FIG. 4 is a flow chart of the present invention;

FIG. 5 is a schematic sectional view of a third embodiment of the present invention;

FIG. 6 is a schematic sectional view of a screening device of the second embodiment of the present invention;

FIG. 7 is a schematic sectional view of a screening device of the third embodiment of the present invention;

FIG. 8 is an analytic perspective view showing a driving device of the second embodiment of the present invention.

### DETAILED DESCRIPTION OF THE PREFERRED EMBODIMENT

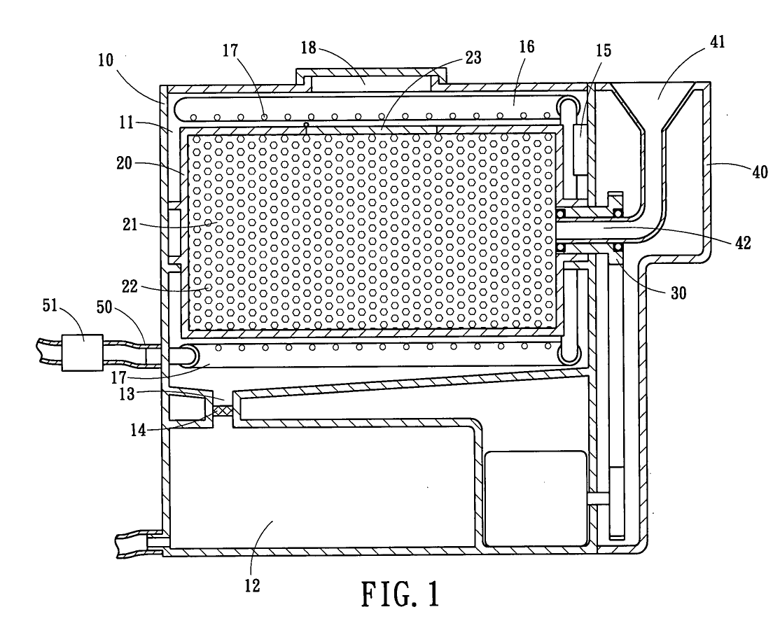

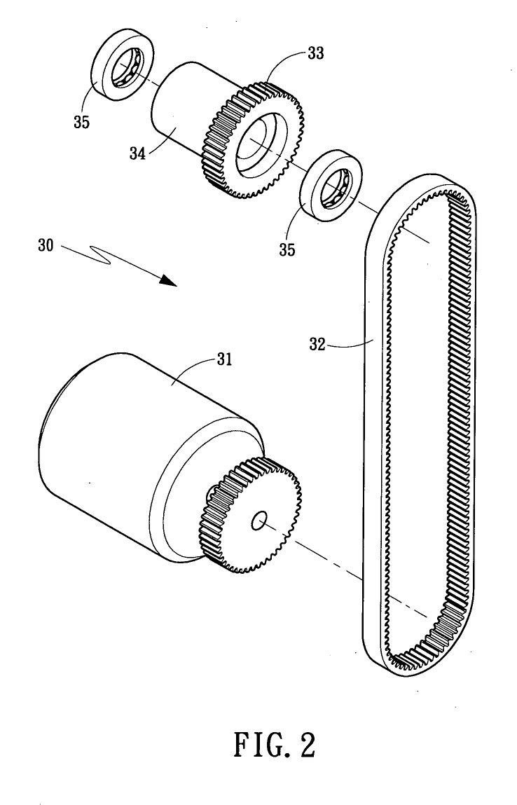

The “treating apparatus for organic waste” of the present invention shown in FIGS. 1 and 2 comprises:
a machine 10 provided therein with a receiving room 11 and a water cleaning room 12 connected with each other by using a conduct 13, the conduct 13 is provided therein with a filter 14, the receiving room 11 is provided therein with a temperature controller 15, the receiving room 11 further is connected with a pipe 16 which is connected to a water inlet pipe 50 exteriorly of the machine 10, the water inlet pipe 50 is provided with a control valve 51, and the pipe 16 is provided thereon with a plurality of spray holes 17;
a screening device 20 provided in the receiving room 11 of the machine 10, it is provided centrally thereof with a receiving room 21, the receiving room 21 is received therein compound bacteria that can fast bacterialize and decompose organic material, and the screening device 20 is provided with a lot of surrounding holes 22 on the external wall thereof;
a driving device 30 used to drive the screening device 20, it includes a driver 31, a gearing member 32 and a linking member 33, the linking member 33 drives by connecting with the driver 31 via the gearing member 32, and a hollow bearing 34 extends out of the linking member 33 to connect with the screening device 20, the hollow bearing 34 is provided therein with slide members 35; and
an input device 40 provided at one side of the machine 10, it is provided with an input port 41 having an input pipe 42 extending therefrom through the interior of the hollow bearing 34 to be connected into the receiving room 21 of the screening device 20.

Thereby, when waste is poured in the receiving room 21 of the screening device 20 through the input device 40, and the screening device 20 is driven by the driving device 30, feeding amount of water to the pipe 16 in the receiving room 11 can be controlled by a control valve 51, and the water is sprayed to the screening device 20 through the spray holes 17; the temperature in the receiving room 11 is kept constantly within 5-80° C. by means of the temperature controller 15, in order that the compound bacteria and the organic material of the waste in the screening device 20 are fast decomposed by fermentation and hydrated into water, and the water after hydration can be discharged through the holes 22 of the screening device 20, then flow through the filter 14 by means of the conduct 13 and flow into the water cleaning room 12 for performance of deodorization and sterilizing.

By virtue that the hollow bearing 34 extending out of the linking member 33 is provided therein with the slide members 35, when the input pipe 42 is extended into the hollow bearing 34, the linking member 33 can do driving work exteriorly of the input pipe 42 by having the slide members 35.

The inorganic material in the waste is unable to be decomposed by bacterialization, thereby the inorganic material is separated by the screening device 20 and is unable to discharge out of the screening device 20, rather it is collected in the screening device 20. And the machine 10 and the screening device 20 have respectively a first port 18 and a second port 23, when the second port 23 is aligned with the first port 18, the inorganic material collected in the screening device 20 can be taken out of the second port 23 and the first port 18, and compound bacteria required for decomposing by fermentation can be supplemented in time.

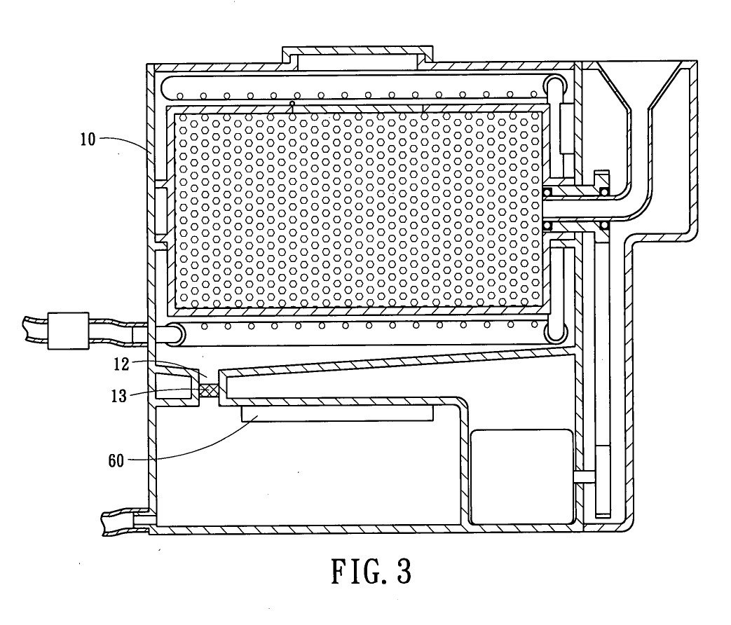

Referring also to FIG. 3, a sterilizing device 60 is provided in the water cleaning room 12, hence when organic material is decomposed and bacterialized to generate water, the water flows into the water cleaning room 12 through the conduct 13 and has the bacteria killed by the sterilizing device 60, then is dischared out of the machine 10.

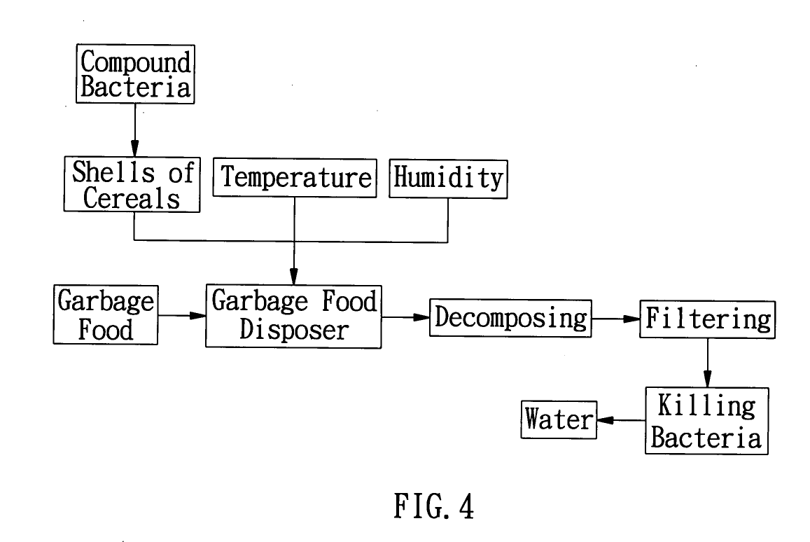

Referring to FIGS. 1 and 4 which is a flow chart of the present invention, the compound bacteria are sprayed onto the surface of the husks of the cereals (such as buckwheat, rice etc.); thereby the husks are enveloped with the compound bacteria (this is a conventional technique, and no further description of it is needed), when they are cast into the screening device 20 of the machine 10, by the fact that the volumes of the husks of the cereals are larger than those of the holes 22 of the screening device 20, they can stay in the screening device 20 without dropping off, when garbage food is cast into the screening device 20, the machine 10 controls the internal temperature and humidity to allow releasing of the compound bacteria attached to the husks, the husks and the garbage food are bacterialized and decomposed, and then are filtered and sterilized to turn into clean water and are discharged.

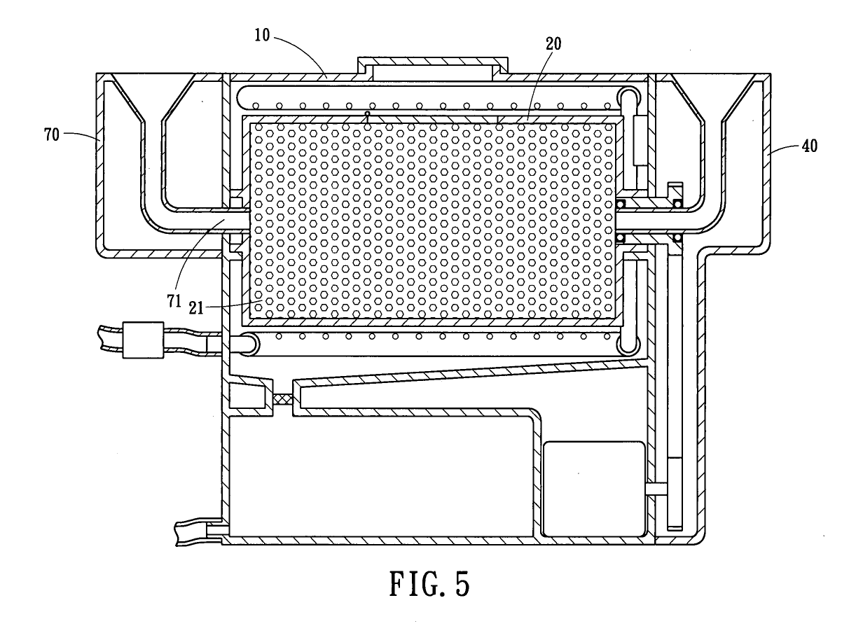

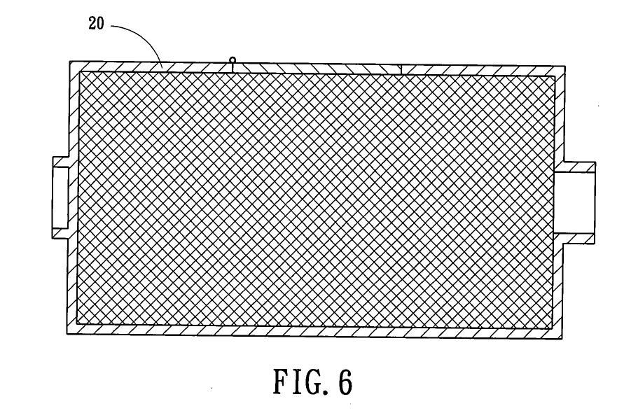

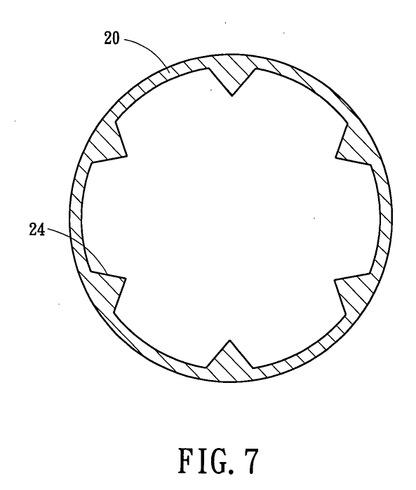

Referring simultaneously to FIGS. 5-7, the machine 10 can be provided with a second input device 70 on the other side thereof in opposition to that having the input device 40, the second input device 70 has a second input pipe 71 extending therefrom and connected into the receiving room 21 of the screening device 20, so that the input device 40 and the second input device 70 can simultaneously input waste; while the external wall of the screening device 20 is formed into a net shape, and the inner wall of the screening device 20 is provided with surrounding protrusions 24, the surrounding protrusions 24 can render the waste in the screening device 20 to be rolled sufficiently to fast and surely hydrate and decompose the organic material in the waste.

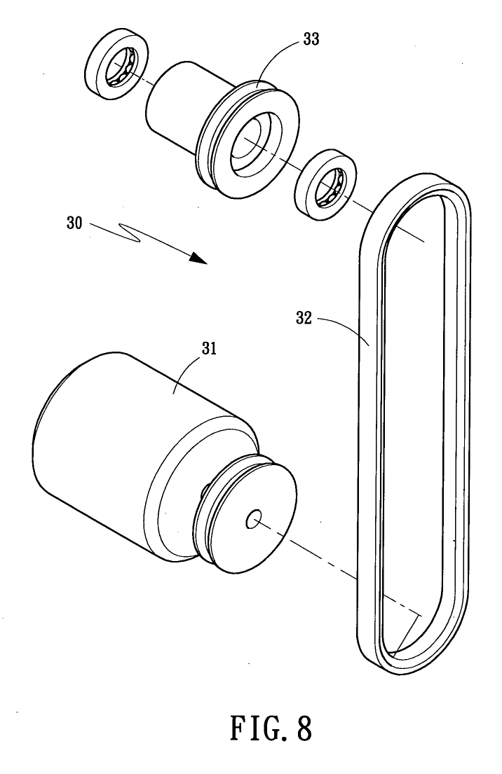

Referring also to FIGS. 2 and 8 which depict that the driving device 30 is composed of the driver 31, the gearing member 32 and the linking member 33, wherein the linking member 33 and the gearing member 32 can be a gear and a chain respectively, and also can instead be a transmitting wheel and a belt for transmission.

As shown in all the attached drawings, the present invention mainly takes advantage of the husks of the cereals attached with the compound bacteria cast into the receiving room 21 of the screening device 20, by the fact that the volumes of the husks of the cereals are larger than those of the holes 22 or the meshes of the net of the screening device 20, they can stay in the screening device 20 without dropping off, thereby when the machine 10 gets suitable temperature and humidity, the compound bacteria can be released from the husks being attached by them and perform bacterialization and decomposing of the organic material; while the inorganic material unable to be decomposed is left in the screening device 20, this can effectively separate the organic material from the inorganic material without losing the compound bacteria; moreover, the first port 18 and the second port 23 can be used to clear the inorganic material remaining in the screening device 20, then further cereals attached with the compound bacteria can be supplemented in time to maintain the effect of bacterialization in the machine 10.

The names of the members are only for illustrating a preferred embodiment of the present invention, and not for giving any limitation to the scope of the present invention. It will be apparent to those skilled in this art that various equivalent modifications or changes made to the present invention without departing from the spirit thereof shall fall within the scope of the appended claims.

1. A treating apparatus for organic waste, said apparatus comprises:
a machine provided therein with a receiving room and a water cleaning room connected with each other with a conduct;
a screening device provided in said receiving room of said machine, said device is provided centrally thereof with a receiving room, said receiving room is received therein compound bacteria that fast bacterialize and decompose organic material;
a driving device to drive said screening device; and
an input device provided at one side of said machine, said input device is provided with an input port having an input pipe extending therefrom to be connected into said receiving room of said screening device;
thereby, when waste is poured in said receiving room of said screening device through said input device, and said screening device is driven by said driving device, this makes said compound bacteria and said organic material of said waste in said screening device be fast decomposed by fermentation and hydrated into water, and then said water flows through said filter by means of said conduct and flows into said water cleaning room for performance of deodorization and sterilizing.

2. The treating apparatus for organic waste as claimed in claim 1, wherein said conduct is provided therein with a filter.

3. The treating apparatus for organic waste as claimed in claim 1, wherein said receiving room is provided therein with a temperature controller for keeping temperature in said receiving room in the range of 5-80 ° C.

4. The treating apparatus for organic waste as claimed in claim 1, wherein said receiving room further is connected with a pipe which is connected to a water inlet pipe exteriorly of said machine, said water inlet pipe is provided with a control valve, and said pipe is provided thereon with a plurality of spray holes.

5. The treating apparatus for organic waste as claimed in claim 1, wherein said screening device is provided with a lot of surrounding holes on an external wall thereof.

6. The treating apparatus for organic waste as claimed in claim 5, wherein said external wall of said screening device is formed into a net shape.

7. The treating apparatus for organic waste as claimed in claim 5, wherein an inner wall of said screening device is provided with surrounding protrusions, said surrounding protrusions render said waste in said screening device to be rolled sufficiently to fast and surely hydrate and decompose organic material in said waste.

8. The treating apparatus for organic waste as claimed in claim 1, wherein said driving device includes a driver, a gearing member and a linking member, said linking member drives by connecting with said driver via said gearing member, and a hollow bearing extends out of said linking member to connect with said screening device, said hollow bearing is provided therein with slide members.

9. The treating apparatus for organic waste as claimed in claim 8, wherein said gearing member and said linking member respectively are a gear and a chain for transmission.

10. The treating apparatus for organic waste as claimed in claim 8, wherein said gearing member and said linking member respectively are a gearing wheel and a belt for transmission.

11. The treating apparatus for organic waste as claimed in claim 8, wherein an input pipe extends through the interior of said hollow bearing to be connected into said receiving room of said screening device.

12. The treating apparatus for organic waste as claimed in claim 1, wherein said machine is provided with a second input device on one side thereof in opposition to said side of said machine having said input device, said second input device has a second input pipe extending therefrom and connected into said receiving room of said screening device, so that said input device and said second input device simultaneously input waste.

13. The treating apparatus for organic waste as claimed in claim 1, wherein a sterilizing device is provided in said water cleaning room, hence when organic material is decomposed and bacterialized to generate water, said water flows into said water cleaning room through said conduct and has bacteria killed by said sterilizing device, then is discharged out of said machine.
